(19) United States
(12) Patent Application Publication
(10) Pub. No.: US 2006/0083826 A1
(43) Pub. Date: Apr. 20, 2006

(54) Device for the transportation and storage of edible produces within a preserving gaseous atmosphere

(76) Inventors: Jean Michel Olhagaray Baeremaecker, Santiago (CL); Fernando Ostornol Almarza, Santiago (CL)

Correspondence Address: SHLESINGER, ARKWRIGHT & GARVEY LLP, 1420 KING STREET, SUITE 600, ALEXANDRIA, VA, 22314, US

(21) Appl. No.: 10/968,130

(22) Filed: Oct. 20, 2004

(51) Int. Cl. A23B 7/148

(52) U.S. Cl. 426/106

(57) ABSTRACT

A method for packaging perishable products, which permits to apply a preserving atmosphere in the surroundings of the perishable products, comprising placing portions of the perishable products in semi-permeable bags; setting one or more of the semi-permeable bags, which hold the portions of perishable products, inside shipment boxes, which have slots or openings in their side walls; placing a number of the shipment boxes on a transport platform or pallet, so that the shipment boxes remain next to each other and in such a way that vertical layers of shipment boxes are formed, thus defining a block of shipment boxes on the pallet; and wrapping the external surface of the block of shipment boxes with a layer of generating means of preserving gas and with a layer of semi-permeable cover; and fastening the layer of semi-permeable cover to make up a stable wrapping.

### FIELD OF THE INVENTION

The present invention is related to a method for the packaging of perishable products, and to a packaging where said method has been applied, by means of the application of a preferably preserving controlled atmosphere. With preference, the perishable products are vegetables and, more preferably, the perishable products consist of fruits.

### BACKGROUND OF THE INVENTION

There is ample knowledge of the variety of methods for packaging and/or packing perishable products, such as food products or others, by using a preserving atmosphere. Among this variety of methods which provide a preserving atmosphere, two large categories may be distinguished, according to their immediate objective: a) methods oriented to providing specific chemical compounds which will release preserving gases or inert gases which displace oxygen; and b) methods which deal with the supply of certain physical conditions in the packaging so that the preserving atmosphere inside it, can maintain the chemical properties expected. The present invention falls within this last category.

Certain types of chemical compounds commonly used to maintain an atmosphere free of specific micro-organisms in fruits, especially table grapes, are those which release sulphurous anhydride (also called sulphur dioxide, whose chemical formula is SO2). These compounds are placed in the so-called “generators”, which are devices made up of paper or semi-permeable plastic sheets, between which an active component is lodged, generally meta-bisulfite or sodium bisulfite. The meta-bisulfite or sodium bisulfite, at the moment of getting in contact with humidity generates sulphurous anhydride.

The microbiostatic and/or microbicidal effect of gaseous sulphurous anhydride is well known, especially its action against fungi which attack and degrade vegetable produces. Additionally, the SO2 generated in the atmosphere which surrounds a fruit, especially in the case of table grapes, has an anti-oxidizing effect, a fact that improves the appearance of the grape bunch stalk, by keeping its green color. In its physiological action, sulphurous anhydride delays the metabolism of the berry up to 80% thus delaying the natural senescence of the fruit.

Even if sulphurous anhydride has a useful fungicide action (particularly suitable to combat fungus Botrytis cinerea Pers frequently found in grapes), it also shows some phytotoxic characteristics. Although grapes may present a good tolerance to this phytotoxicity of SO2, due to the fact that this fruit lacks functional stomas and has a complex cuticular matrix composed of natural waxes, this gas permeates through skin breaks, microscopic wounds and natural openings (lenticels), concentrated around the pedicel, and produces berry whitening or bleaching, due to the destruction of chlorophyll and/or anthocyanic or carotenoid compounds found in the external layers of the berry. This whitening or bleaching affects all cultivations, nevertheless, this symptom is more evident in red and black berries cultivations.

The state of the art does not efficiently address the reduction of the berries' whitening or bleaching when sulphurous anhydride is used in the packaging to control the development of microorganisms. In general terms, the methods of the state of the art consist in placing SO2 generators inside the package of the fruit (kept at refrigeration temperature), in a containing bag, thus permitting a certain accumulation of humidity in the environment and enabling the reaction of the generator compound to produce sulphurous anhydride. Normally, a unit is placed on top of the fruit, preventing the direct contact with the fruit by means of a barrier of absorbent paper. In some cases, and as a complement, a generator in the bottom of the box may be used, but always within the containing bag. The concentration of SO2 is maintained for the time required for the cold storage duration, it suffices that this concentration holds itself between 3 and 7 ppm, for fungistatic control. In these techniques of the state of the art, the containing bags are pierced to avoid an excessive accumulation of SO2.

Commonly, it is expected that the grapes box be maintained at 0° C. with no breakage of the cold chain; however, this is not always accomplished. There is a direct relationship between the temperature and the emission rate of sulphurous anhydride, a fact that may prove critical in regard to levels of tolerance and damage due to the action of sulphurous anhydride, which especially produces the undesirable berries' whitening or bleaching.

The present situation provides a packaging method, and a package as such, which makes use of the generators of preserving gases, preferably—although not limited to—SO2 generators, but without the phytotoxicity inconveniences derived from the current way of using said generators.

Basically, the method of the present invention involves, the same as the previous art, the packaging of fruit in semi-permeable bags, and these bags are placed inside boxes with openings to allow the circulation of cold air, humidity and the eventual preserving gases or those applied for quarantine reasons. In turn, these boxes are piled up, placing these piles, next to one another, in an orthogonal array, to define a block of boxes, which is “arranged” on a transportation platform, better known as pallet. This pallet, with the block of boxes, is wrapped with a cover impervious to gases and with openings, or, with a cover permeable to gases, with or without additional openings. So far, the present invention looks common to the state of the art.

Yet, while said state of the art involves placing preserving gas generators inside each semi-permeable bag (together with the fruit), which is placed in each box of the block formed on the pallet, the present invention—on the contrary—involves placing the gas generating means between the internal face of the cover that wraps the pallet that contains the box block and the surface of said block. This arrangement permits that the gas generated does not act in high concentrations in the vicinity of the fruit, as it occurs when the generators are in each bag of each box, according to the teachings of the previous art.

### BRIEF DESCRIPTION OF THE DRAWINGS

To better understand the arrangement of the elements and the sequence of operation, according to the method of the present invention, a full description of this will be made, in reference to the drawings of a preferred modality, where:

FIG. 1 shows a diagram of a packaging of the present invention, arranged according to a preferred modality offered by this invention, where it can be appreciated through a partial section. In this modality, the means to generate preserving gas are arranged as segmented bands which overlap on the transport block boxes.

FIG. 2 shows a second partial diagram of a second modality of the invention, where the means to generate preserving gas are attached to the cover layer of the transport boxes block.

### DETAILED DESCRIPTION OF THE INVENTION

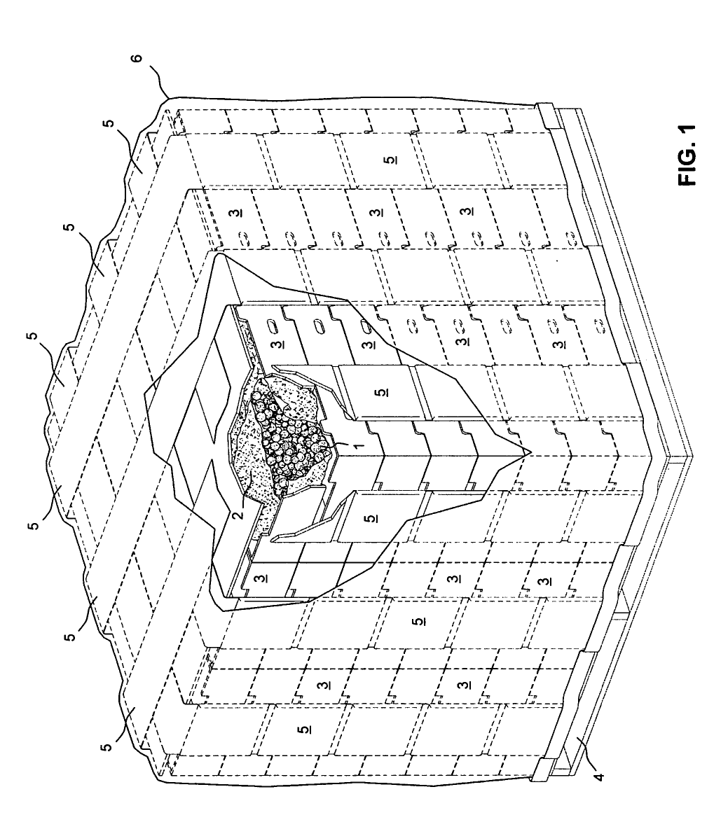

As it can be seen in FIG. 1, fruit 1 is contained in semi-permeable bags 2, which permits to retain the atmosphere surrounding the fruit, both regarding its humidity as well as the preserving gases that get into said semi-permeable bag 2. By stating “to retain” the atmosphere, it is meant that this atmosphere faces a certain obstacle to migrate toward the rest of the surroundings, a fact that decreases the fruit dehydration and increases the permanence of the preserving gas coming from the generators, different from what it would occur should these semi-permeable bags not exist. Semi-permeable bags 2 can have the aforementioned characteristic either because they are made of a sheet that possesses this characteristic and/or because they have perforations in their surface.

Should they be used, one or more of these semi-permeable bags 2, containing fruit, are placed in shipment boxes 3, which are well known in the art. These shipment boxes are usually made of cardboard, wood or synthetic material and they have slots or openings in their side walls to facilitate the thermal exchange between the cold chambers and the fruit, as well as to allow suitable air circulation, thus enabling to homogenize the temperature, humidity and concentration of the preserving gas.

Several shipment boxes 3 are placed on a transport platform or pallet 4, one next to the other in an arrangement generally orthogonal, in the case that said shipment boxes 3 have a rectangular base, and in such a way that vertical layers of shipment boxes 3 are formed.

In this state of block grouping of shipment boxes 3 on pallet 4, the external surface of the block of boxes is wrapped with a layer of means that generate preserving gas 5, and with a semi-permeable cover layer 6.

The layer of means that generate preserving gas consists, preferably, of a plurality of cells generating sulphurous anhydride, or of a continuous generating element. Said elements, continuous or discrete, are based on the active component, encapsulated or free sodium bisulfite or meta-bisulfite, and retained between two sheets, with at least one of these sheets being permeable to the gases. This, at least one, sheet permeable to the gases from the generators, must be oriented to the surface of the block of shipment boxes 3.

Notwithstanding the former, the present invention is not solely restricted to this specific type of sulphurous anhydride generators, as it can be applied to generators of chlorine, chlorine dioxide, ozone or other preserving gases used in the art of preservation of fresh vegetable produces.

The semi-permeable cover layer 6 may be made up of a sheet impervious to gases and with openings, or of a sheet permeable to gases, with or without additional openings.

Depending on the manner in which the layer of preserving gas generating means 5 is interposed, different modalities are obtained of the method and packaging of the present invention.

In the first modality of the invention, illustrated in FIG. 1, the means to generate preserving gas 5 consist of continuous segmented bands in which each segment defines a generator unit or cell. In the case of continuous generating means, the active element is uniformly spread within the inner part of the band. Several of these continuous segmented bands, are distributed on the block of shipment boxes 3, arranged in a substantially vertical manner and parallel between one another, and in such a way that sections of this band hang on each side of the block, the sections extending downwards until they reach the level of pallet 4. A second layer of these means that generate preserving gas 5 may be placed on the block of shipment boxes 3, in a manner substantially transversal to the direction of the bands of the first layer.

Actually, the preserving gas generator cells which make up each band segment, do not have to be closely contiguous, with a section of “inert” band existing between two cells or group of active cells. Similar consideration is applied in the case of generating means with uniform active components or continuously spread in the band. This particularization is not opposed to what has been formerly stated: “continuous segmented bands, in which each segment defines a generator unit or cells” if it is understood that two contiguous cells must, necessarily, have an area of separating sheet that is the one which, precisely, defines the border between one cell and its neighbor. Likewise, the inert band areas or separation areas may vary in width between one cell and another.

A specific case of a segmented, continuous band, where each segment defines a generator unit and the bordering areas between the cells is constituted by the case illustrated in FIG. 1, where the band extension that covers the upper surface of the block of transport boxes 3 consists of a single and widespread inert area, that is to say, with no generator cells of preserving gas.

In this first modality of the invention, the semi-permeable cover 6 may, simply, consist of a flexible semi-permeable sheet which wraps the set formed by the block of shipment boxes 3 and the layer or layers of continuous segmented bands which define the generating means of preserving gas 5, and where this wrapping is fixed, in its necessary packing folds, by means of ties, staples or adhesives.

A second modality of the invention consists in a different way of associating the sequence box block/generating means/cover, where said generating means of preserving gas 5 are affixed to the semi-permeable cover 6, before this one wraps the transport box block 3 which is already installed on pallet 4.

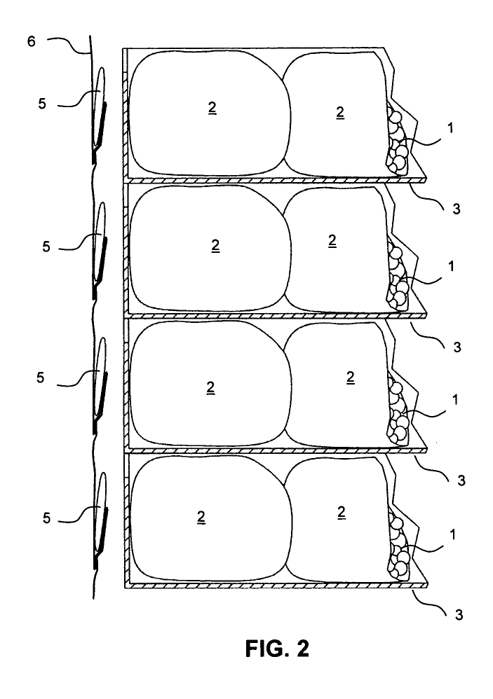

One way of fastening the generating means of preserving gas 5 to cover 6 may consist in arranging units of said generators 5 in folds formed on said cover 6, like pockets, as illustrated in FIG. 2. Another way of fastening these generating means 5 to cover 6 may be done by means of adhesives. Even another way of fastening between generating means 5 and cover 6 may consist of a thermal sealing, provided that the contact surfaces of these elements are made of thermofusible materials.

Certain generalizations or variants of the invention, must be considered as obvious and, therefore, included in the present description. For instance, the orientation of the segmented bands containing the preserving means, may be different from the vertical; thus, these bands may be installed around the box block according to a horizontal, or slanted orientation, or wrapping them like a wool ball, provided that the main idea of the invention is maintained that is, to place the generating means of preserving gas outside the block of boxes and protected by a semi-permeable cover.

1. A method for packaging perishable products, which permits to apply a preserving atmosphere in the surroundings of said perishable products, comprising:
a) placing portions of perishable products in semi-permeable bags;
b) setting one or more of said semi-permeable bags, which hold said portions of perishable products, inside shipment boxes, which have slots or openings in their side walls;
c) placing a number of said shipment boxes on a transport platform or palleta, so that said shipment boxes remain next to each other and in such a way that vertical layers of shipment boxes are formed, thus defining a block of shipment boxes on said pallet; and
d) wrapping the external surface of said block of shipment boxes with a layer of generating means of preserving gas and with a layer of semi-permeable cover.
e) fastening said layer of semi-permeable cover to make up a stable wrapping.

2. A method according to claim 1, wherein said perishable products are vegetables.

3. A method according to claim 2, wherein said vegetables are table grapes.

4. A method in according to claim 1, wherein said layer of generating means of preserving gas which surrounds the external surface of said block of shipment boxes being formed by means of the arrangement of a number of segmented, continuous bands, in which each segment defines a unit of generator of preserving gas or generator cells; where said arrangement of segmented bands on said block of shipment boxes consists in arranging said segmented bands in a manner substantially parallel between each other, and in such a way that sections of said segmented band hang down on each side of said block; with said sections of said block hanging down, until they reach the level of said pallet.

5. A method according to claim 4, wherein a second layer of said segmented bands, that define said generating means of preserving gas, is placed on said block of shipment boxes; the segmented bands of this second layer being oriented in a direction substantially transversal to the direction of the segmented bands of said first layer of segmented bands.

6. A method according to claim 1, wherein said layer of generating means of preserving gas that surrounds the external surface of said block of shipment boxes is formed by fastening said generating means of preserving gas on said semi-permeable cover, before this one wraps said block of shipment boxes which is already formed on said pallet 4.

7. A method according to claim 6, wherein said fastening of gas generating means on said semi-permeable cover consists in placing units of said generators in folds formed in said cover, like pockets.

8. A method according to claim 6, wherein said fastening of gas generating means on said semi-permeable cover consists in affixing them through the use of adhesives.

9. A method according to claim 6, wherein said fastening of generating means of preserving gas on said semi-permeable cover consists in affixing them through thermal sealing.

10. A packaging for perishable products, which permits to apply a controlled atmosphere in the surroundings of said perishable products, wherein said packaging comprises:
a) a number of shipment boxes, holding semi-permeable bags within which portions of said perishable product have been placed; said number of shipment boxes being assembled and piled up, in a bordering relationship, to make up a block which rests on a transport platform or pallet;
b) a layer of generating means of preserving gas, which surrounds the external surface of said block of shipment boxes; and
c) a layer of semi-permeable cover which wraps the set formed by said block of shipment boxes and said layer of generating means of preserving gas; where the wrapping thus formed is fastened by means of ties, staples or adhesives.

11. A packaging according to claim 10, wherein said layer of preserving gas generating means consists of a number of sulphurous anhydride generating cells.

12. A packaging according to claim 11 wherein said sulphurous anhydride generating cells are on sodium meta-bisulfite held between two sheets, with at least one of these sheets being permeable to gases; with this, at least, one sheet permeable to gases, being oriented towards the surface of said block of shipment boxes.

13. A packaging according to claim 10, wherein said layer of semi-permeable cover are constituted by a sheet impervious to the gases and which has openings.

14. A packaging according to claim 10, wherein said layer of semi-permeable cover is constituted by a sheet permeable to gases.

15. A packaging according to claim 14, wherein said sheet permeable to gases which forms said layer of semi-permeable cover additionally has openings.

16. A packaging according claim 10, wherein said layer of preserving gas generating means which surrounds the external surface of said block of shipment boxes consists of a number of continuous, segmented bands, where each segment defines a unit of preserving gas generator or generating cells; said number of segmented bands being arranged in a manner substantially parallel between each other, and in such a way that sections of said segmented band hang down on each side of said block; with said sections extending downwards on said block, until they reach the level of said pallet.

17. A packaging according to claim 16, wherein a, substantially similar, second layer of segmented bands is placed on top of said layers of segmented bands, and in such a way that their segmented bands are in a direction substantially transversal to the direction of the segmented bands which make up the first layer of segmented bands.

18. A packaging according to claim 16 wherein said segments which define the respective units of preserving gas generators of said segmented band, are separated one from the other by a corresponding portion of said band which does not hold preserving gas.

19. A packaging according to claim 18, wherein the portions of said band which do not hold preserving gas generators have an extension which is not equal in, at least, one of said portions not holding gas generators.

20. A packaging according to claim 10, wherein said layer of preserving gas generating means which surrounds the outer surface of said block of shipment boxes consists of preserving gas generating means which are attached to said semi-permeable cover, on the surface which will face the inner part of the packaging.

21. A packaging according to claim 20, wherein said gas generating means are attached to said semi-permeable cover by arranging said units of said generators in folds made in said cover, like pockets.

22. A packaging according to claim 20, wherein said gas generating means are attached to said semi-permeable cover by means of adhesives.

23. A packaging according to claim 20, wherein said gas generating means are attached to said semi-permeable cover by means of thermal sealing.
